(19) United States
(12) Patent Application Publication
(10) Pub. No.: US 2005/0238456 A1
(43) Pub. Date: Oct. 27, 2005

(54) Fastener for the temporary joinder of parts made of composite material

(76) Inventor: Dennis Stinson, Brooklyn Threshfield (GB)

Correspondence Address: Donald D. Mon, Suite 303, 750 East Green Street, Pasadena, CA, 91101, US

(21) Appl. No.: 10/995,006

(22) Filed: Nov. 20, 2004

Related U.S. Application Data
(63) Continuation-in-part of application No. 10/831,968, filed on Apr. 26, 2004.

(51) Int. Cl. F16B 13/04

(52) U.S. Cl. 411/34

(57) ABSTRACT

A re-useable fastener intended for the temporary assembly of a pair of objects that are made from composite material. The fastener body itself is made of a self-shape restoring elastomer with a tubular shank to be placed in aligned holes in the parts. It has a head at one end of the shank and an axial passage from head end to blind end. A headed, threaded bolt fits in the passage. A metal washer fits against the head, around the passage. An internally threaded insert is fitted in the shank to receive the bolt with its head against the washer. When tightened, the blind end of the shank forms a bulb, and the shank enlarges. When untightened, the body relaxes and the body can be removed. Alternatively, the bolt head can bear against the blind end, and a nut can be threaded onto the bolt shank, bearing against the washer to set the fastener. If desired a tubular rigid body can be placed inside the passage within the depth of the holes to limit the deformation of the shank inside the hole.

### CROSS-REFERENCE TO OTHER APPLICATION

This is a continuation-in-part of applicant's U.S. patent application Ser. No. 10/831,968, filed Apr. 26, 2004, titled “FASTENER FOR THE TEMPORARY JOINDER OF PARTS MADE OF COMPOSITE MATERIAL, which will be abandoned after the timely filing of this continuation-in-part application.

### FIELD OF THE INVENTION

The temporary joinder of parts which are made from composite materials, utilizing a blind fastener.

### BACKGROUND OF THE INVENTION

When parts of a total assembly are to be joined permanently, it is common practice initially to gather them in place on a fixture or a jig, and then fastener-by-fastener, secure them together to form the final assembly. The initial assembly of parts is held together by temporary fasteners, which are individually removed at the time when a permanent fastener is to be installed in their place. This initial assembly is made from one side only (a “blind” assembly) for convenience of the assembler. Using fasteners tightened from both sides would be unnecessarily time consuming and often not possible, for example when the final fastener is itself a blind fastener.

This is not, of course, a new concept. Since the earliest days of aircraft assembly it has been a conventional procedure. Temporary fasteners are well known for this purpose. A historical example is the CLECO, which provides hooks on its blind end to engage the back side of a part around the hole. These are hard metallic fasteners that are well enough suited for use with metal structures such as an aluminum alloy stringers. Such parts are ordinarily not notch-sensitive, and small scratches and indentations caused by assembly techniques are acceptable.

The situation is different with composite materials. These materials are formed from organic plastics reinforced with substances such as fibers and cloths. These are less forgiving of damage done during assembly of a structure. A hole and its boundaries, once formed, must be protected against damage.

It is an object of this invention to provide a temporary fastener which presents only conformable surfaces to the composite material, which fastener is readily installed, and is readily removed. Meanwhile when installed it provides a suitable and sufficient structural fastener to hold the parts together in proper relationship.

### BRIEF DESCRIPTION OF THE INVENTION

The temporary fastener of this invention includes a body having a central axis, an axially extending tubular shank with a laterally-extending head at its headed end and a blind end spaced from the head. This body is formed from a compliant material that can be deformed by sufficient force to form an upset on the blind end that with the head on the head end will hold the parts together without deforming the parts themselves or damaging their confronting surfaces.

A puller comprises a headed and a threaded shank. A washer surrounds the axial passage at the headed end, providing a rigid engagement surface for the puller.

In one embodiment of this invention, the head of the puller bears against the washer, and is threaded into an insert that is cast into the blind end of the shank of the body.

In yet another embodiment, the head of the puller bears against the blind end of the shank of the body, and a nut is threaded onto the puller shank, bearing against the washer, to pull the blind end toward the head and upset the body shank to form a bulge that holds the parts together.

According to a preferred but optional feature of the invention, the body has incorporated into its tubular shank a rigid reinforcement located between the head and the blind end of the shank, terminating at an axial location along the shank spaced from the blind end so as to leave an un-reinforced portion of the shank available to form a temporary enlargement, called herein a bulge or an upset. This reinforcement can be inside the shank or outside of it, as preferred and may include a head of its own.

According to another optional feature of the invention, the shank has an outer wall with a tapered shape that has a cross-section increasing in diameter from the blind end to facilitate insertion of the shank into a workpiece.

In all situations the fastener can be released and withdrawn merely by unthreading the puller or its torque device. The body then shrinks to its previous dimensions so as readily to be removed.

The above and other features of this invention will be fully understood from the following detailed description and the accompanying drawings, in which:

### BRIEF DESCRIPTION OF THE DRAWINGS

FIG. 1 is a side view of the preferred embodiment of the fastener of the invention;

FIG. 2 is an axial cross-section taken at line 2-2 in FIG. 1;

FIG. 3 is a top view taken at line 3-3 in FIG. 1;

FIG. 4 is an axial cross-section showing the fastener loosely assembled;

FIG. 5 is a view similar to FIG. 4, but with the fastener inserted into the parts to be joined.

FIG. 6 shows the fastener fully installed;

FIG. 7 is an exploded view of the components of the fastener with a modification;

FIG. 8 is an axial cross-section of another embodiment of the invention;

FIG. 9 is an axial cross-section of a metal reinforcement preferably formed as part of a washer, and embedded into the body;

FIG. 10 is an end view of FIG. 9;

FIG. 11 is an axial cross-section of the preferred embodiment of this fastener loosely inserted in a workpiece;

FIG. 12 is a view similar to FIG. 11, but with the fastener set;

FIG. 13 is an axial cross-section showing another modification of the invention, unset; and

FIG. 14 is yet another axial cross-section showing another embodiment of the invention unset.

### DETAILED DESCRIPTION OF THE INVENTION

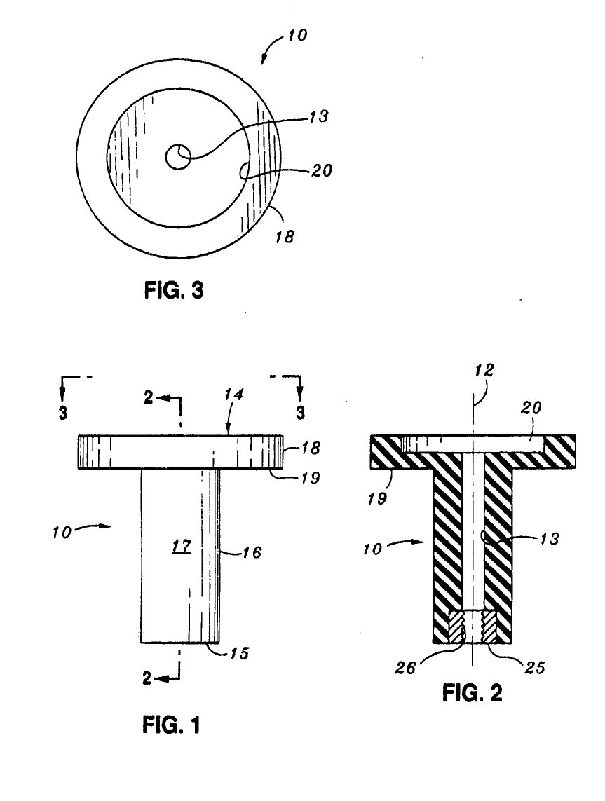

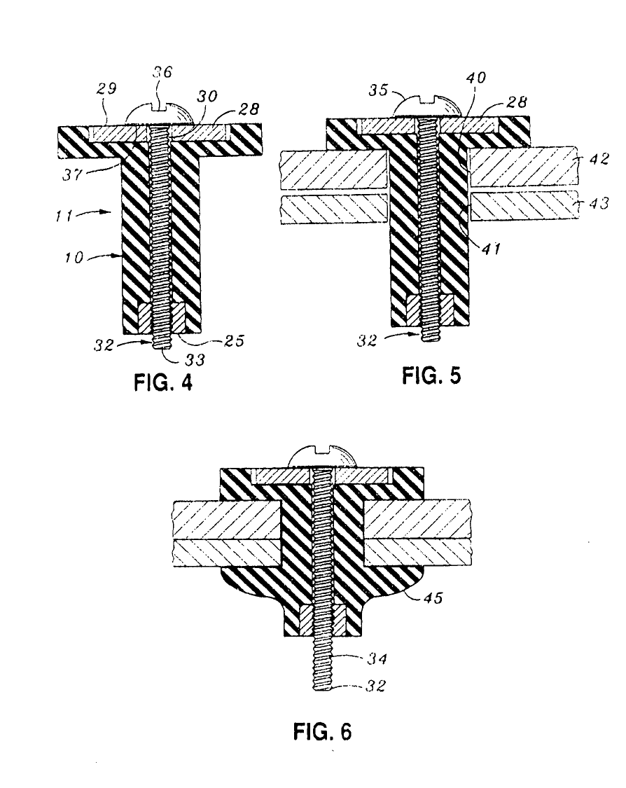

Referring to the drawings, FIG. 1 shows the body 10 of a fastener 11 (FIG. 4) according to the invention. body 10 has a central axis 12 with an axial passage 13 extending from its headed end 14 to its blind end 15.

The body includes a tubular shank 16 with an outer cylindrical surface 17. It further includes a laterally extending head 18 with a shoulder 19. In the preferred embodiment a recess 20 is formed around the opening of the passage at the headed end.

An insert 25 is pressed or cast into the blind end of the fastener. It carries an internal thread 26. The insert is preferably made of metal, often brass.

As best shown in FIGS. 4-6, a metal washer 28 has an upper contact surface 29 and a central hole 30. It fits neatly into recess 20.

A puller 32 comprises a bolt having a shank 33 with an external thread 34. Thread 34 is engageable with thread 26 in the insert, but clears the wall of the passage and the wall of the hole in the washer. Its function is to engage the insert and put shank 16 into compression.

The puller further includes a head 35 which bears against contact surface 29. A screw slot 36 or other tool-engagement means such as a socket is formed in the head to turn the puller. It will be noted that the under surface 37 of the puller head is smooth so as to reduce resistance to turning the puller when the fastener is being installed.

FIG. 5 shows the loose fastener placed in holes 40, 41 in parts 42 respectively. Notice the freedom of fit, with clearances between the walls of the holes and the outer surface of the fastener. The fastener can readily be inserted. This invention provides its best advantages for temporary assembles of parts made of composite materials although it is useful with other materials as well, such as aluminum alloys, and steel alloys.

As shown in FIG. 6, the puller can be rotated. The effect is to pull the insert toward the head of the body. In so doing, it will swell the shank of the body to fit closely in the holes in the parts. This will serve to align them. It will also create a bulge 45 on the blind end which acts as a clamp with the head of the body to press the parts together. The temporary assembly is now completely rigid.

To release it, the puller is simply unthreaded. The fastener will relax and can readily be removed and re-used. This relaxation is the consequence of the character of the body to restore itself to its relaxed shape.

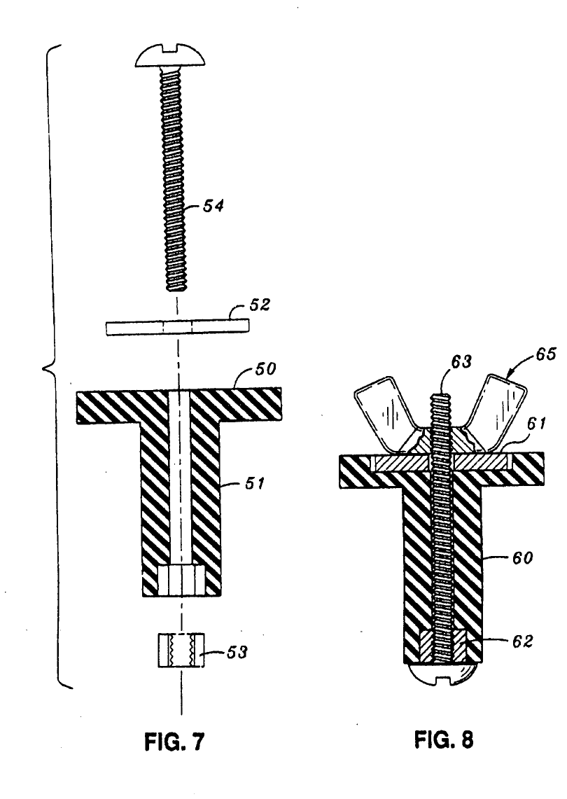

FIG. 7 illustrates that the top surface 50 of a body 51 need not be recessed. The washer 52 may instead bear directly on the top surface. As before, the fastener includes an insert 53 and a puller 54, assembled and installed as above.

The embodiments of FIGS. 1-7 require the use of a separate tool, such as a screwdriver or a hex wrench to install it. In contrast the embodiment of FIG. 8 is self-contained both as to structure and as to installation.

This embodiment utilizes a body 60, a washer 61 and an insert 62 as before. The same parts can be used. The difference is the reversed insertion of puller 63. This puller enters the from the blind end. The head of the puller now bears against the insert. In this embodiment the puller is not threaded to the insert. A clearance is provided, or the insert is not threaded. The head of the puller bears against the insert, or if an insert is not used, then directly on the body shank.

A torque device 65, such as a classical wing nut is threaded onto the shank of the puller, and bears against the washer.

The function is the same for the fastener of FIG. 1, but provides the advantage of a self-contained torque device. This will often be a substantial convenience, because no separate torque tool is needed to set the fastener. In every situation the fastener can be removed at its headed end.

The body may be made from any suitable elastomer which is sufficiently deformable as to be radially enlarged when axially compressed, and tends to be self-shape restoring when deforming forces are released.

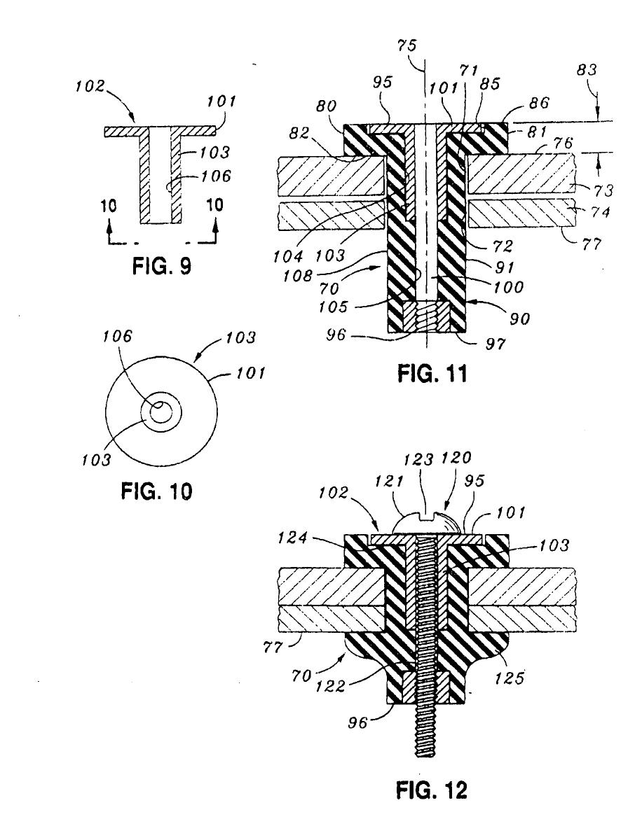

FIGS. 9-12 show the presently-preferred embodiment of this invention. While the embodiments of FIGS. 1-8 work well, it has been found to be useful to provide a fastener which is more readily inserted into the workpiece, and in which the region where the enlargement occurs is primarily limited to a defined axial length of the fastener, and with a lesser expansive contact of the shank with the walls of the workpiece. I has been observed that the excessive early swelling of the shank can impede the arrays of the workpieces together. Also, it is useful to limit contact of the puller with the elastomer. This can reduce the torque necessary to set the fastener.

FIG. 11 shows a fastener 70 according to this invention loosely inserted into a pair of holes 71,72 in workpieces 73,74, respectively. These holes are aligned and on a common central axis 75. It is the purpose of this fastener to clamp against upper surface 76 of workpiece 73 and bottom surface 77 of workpiece 74 to hold them together temporarily.

The workpieces may be of any material, such a composites and metals. The fastener provides best advantage to composites because of it is forgiving of the wall surfaces. It will not crack or depress these walls.

Fastener 70 includes a body 80 having a lateral extending head 81 with an undersurface 82 which bears against workpiece surface 76, extending beyond the holes. It has a height 83, which preferably is tall enough to receive a tool such as pliers to pull the fastener out of the holes when the fastener is to be removed. The body has an annular recess 85 in the upper surface 86 of its head 81.

A tubular shank 90 is integral with head 87 and depends from it. The shank has an outer wall 91 which may be cylindrical, but preferably has a small taper (draw) angle of perhaps three degrees included angle. This is enough taper to facilitate pressing the fastener into the holes, but not so large as to result in looseness of fit when the fastener is set.

The body extends from its headed end 95 to its blind end 96. A nut 97 is cast into the blind end of the shank.

Annular recess 85 in the top surface of the head receives annular flange 101 of a rigid reinforcement 102. The reinforcement has a tubular shank 103 which fits into an internal enlargement 104 in the inside wall 105 of shank 90. Preferably the reinforcement is molded in place, but it could instead be cemented in or simply pressed in. The reinforcement is made of rigid material such as brass, an aluminum alloy, or a rigid plastic.

Passage 105 extends from the head end of the fastener to its blind end 96. It is defined by the inside wall 106 of the reinforcement and by the portion of the shank beyond the reinforcement.

It will be observed that the reinforcement terminates short of the insert and of the blind end. This leaves the unsupported length 108 of the shank exposed beyond bottom surface 77 of workpiece 74. By supporting the wall of shank 90 between the shank 103 the reinforcement and the walls of the hole, the workpiece walls are subjected to a reduced lateral force, but enough that the fastener makes a complete fit. Excessive swelling of the shank in the workpiece could make drawing the parts together more difficult. Also the threads of the puller are not in contact with the wall of the body for much of its length, which reduces the torque needed to turn the puller.

The exposed length of the body is available to form an upset enlargement or bulge 125. This arrangement is shown in FIG. 12. A puller 120 in the form of a bolt has a head 121 and a threaded shank 122. The head is provided with a tool engaging shape such as a slot 123 and a bearing surface 124 which bears against the reinforcement.

The installation of this fastener is straightforward. It is thrust through the holes in the workpiece, blind end first. Then the bolt is turned to draw the nut toward the workpiece (FIG. 12), which bulges the protruding portion of the shank to form bulge 125 shown in FIG. 12.

When the fastener is to be removed, the bolt is turned the other way, backing off the nut. The material of the shank tends to be self-shape restoring, and resumes the condition shown in FIG. 11.

The height 83 of the head of the body provides for a convenient grip by the hand or a tool. Then the fastener can be reused.

The embodiment of FIGS. 11 and 12, utilizing reinforcement 102 reduces the amount of material that needs to be deformed, making the installation easier. The material which contacts the wall of the hole need not expand as much because the clearance is usually quite close. The clamping action is primarily caused by the bulge and the head being brought toward one another by the action of the bolt.

The dimensions of the fastener are arbitrary, and are designed to fill a hole of selected length and diameter. These details are well within the scope of the skilled artisans.

The reinforcement may be incorporated in the arrangement of FIG. 8.

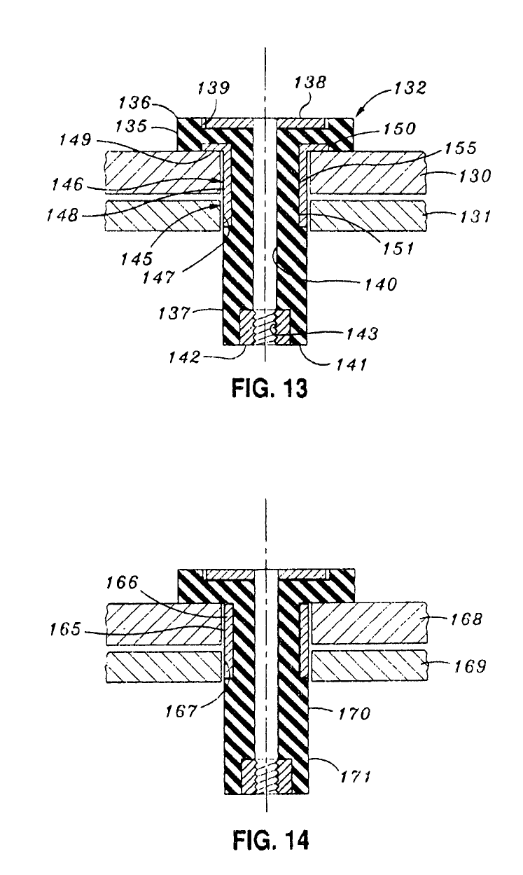

FIGS. 13 and 14 show embodiments of the fastener which facilitate and improve the setting of the fastener. The fastener's principal function is to hold the workpieces together, with the holes aligned. This requires that the parts be pulled together by driving the bulge toward the head. This relative movement of the workpieces is made difficult as the lateral displacement of the shank increases.

Also it can be minimized by having the contact between the fastener and the wall of the holes made by a hard smooth body which does not swell, and incidentally also reduces the contact between the shank of the fastener body and the thread of the puller, thereby also reducing the torque needed to set the fastener.

In FIG. 13, two workpieces 130,131 are shown loosely assembled by a fastener 132. The fastener includes a body 135 with a head 136 and shank 137. A metal washer 138 is sunk in a recess 139 in head 136.

A central passage 140 extends from the head to the blind end 141 of the body. A metal insert 142 with an internal thread 143 is cast or set in the blind end of the body.

A reinforcement 145 fits snugly in holes 146 and 147 in the workpieces. It has a tubular shank 148 and peripheral head 149. Head 149 fits in a recess 150 in the under surface of head 136. Shank 148 fits in a peripheral recess 151 in shank 137 of the body.

There is a remaining tubular section 155 of the body which is restrained force outward swelling, but closeness of fit of the reinforcement will generally be sufficient.

The body length beyond the reinforcement and its free length beyond the workpieces suffices to form a bulge as in FIG. 12. This bulge will be formed by turning a puller, threaded into the insert, as before.

FIG. 14 is similar to FIG. 13, except that reinforcement 165 does not include a head. It is a pure cylinder whose length is about the same as shank 104 of reinforecment 102 in FIG. 12. It fits against the walls 166, 167 of workpieces 168, 169 and reduces the wall thickness of shank 170 of fastener body 171. Apart from this, the embodiments of FIGS. 13 and 14 are identical.

This invention thereby provides an inexpensive, convenient and very efficient temporary fastener that respects the structural integrity of the parts in which it is set. It is readily removable and reusable.

This invention is not to be limited by the embodiments shown in the drawings and described in the description, which are given by way of example and not of limitation, but only in accordance with the scope of the appended claims.

1. A fastener for temporarily joining a pair of parts which are made of a composite material, said fastener having a central axis and comprising:
a body, said body having a headed end and a blind end and including an integral head and an axially extending shank, said head extending laterally beyond said shank and having a shoulder to bear against one of said parts, said shank having a central passage extending axially between the headed end and the blind end, said body being made of deformable elastomeric material;
a metal insert fitted into said passage adjacent to said blind end, said insert having an internal thread;
a puller having a head and an axially extending threaded shank, the thread on said puller shank being proportioned to engage the thread in the insert, said puller having a head with a laterally extending contact surface, said head also having torque tool engagement means; and
a hard washer having a contact surface and a hole therethrough which clears the thread on the puller, the contact surface of the head bearing against the contact surface of the washer;
whereby with the puller inserted through said washer and threaded into the insert, torquing said puller will draw the blind end of the shank toward the headed end, thereby to radially enlarge the shank and form an enlarged bulb on the blind end to hold the parts together and aligned.

2. A fastener according to claim 1 in which said torque tool engagement means is a slot for a driver to engage.

3. A fastener according to claim 1 in which said torque tool engagement means is a socket.

4. A fastener according to claim 1 in which said washer fits into a recess in the head of the body.

5. In combination:
a pair of parts made of composite material with a hole in each to be engaged by a fastener; and
a fastener according to claim 1 in which the shank of the body extends through said holes with the body head bearing against one of the parts and the body shank projecting through and beyond the other part, said puller having been turned to draw the blind end toward the head end, thereby drawing the parts together, filling the holes, and forming a bulb at the blind end.

6. A fastener for temporarily joining a pair of parts which are made of a composite material, said fastener having a central axis, and comprising:
a body, said body having a headed end and a blind end and including an integral head, and an axially extending shank, said head extending laterally beyond said shank and having a shoulder to bear against one of said parts, said shank having a central passage extending axially between the headed end and the blind end, said body being made of deformable elastomeric material,
a puller having a head and an externally threaded shank, the shank fitting loosely in said passage, with the puller head bearing against the shank at its blind end and the thread on the puller projecting beyond the head of the shank;
a metal washer having contact surface and a hole therethrough which clears the thread on the pullet, said washer having a contact surface bearing against the head of the body and a bearing surface on its support side; and
a nut threaded onto the thread of the puller so disposed and arranged as to bear against the bearing surface of the metal washer so that when the nut is turned it causes the head of the puller to press the blind end of the body toward the headed end whereby to swell the body shank and create a bulge at the blind end.

7. A fastener according to claim 6 in which a metal insert is fitted in the passage adjacent to the blind end for the head of the puller to contact.

8. A fastener according to claim 6 in which the nut is a wing nut.

9. A fastener according to claim 6 in which said washer fits in a recess in the body head.

10. In combination:
a pair of parts made of composite material with a hole in each to be engaged by a fastener; and
a fastener according to claim 6 in which the shank of the body extends through said holes with the body head bearing against one of the parts and the body shank projecting through and beyond the other part, said nut being turned to draw the blind end toward the head end, thereby drawing the parts together, filling the hole, and forming a bulb at the blind end.

11. A fastener according to claim 1 in which a reinforcement comprising a tubular rigid body is fitted coaxially in said passage, reducing the radial width of said shank.

12. A fastener according to claim 12 in which said rigid body extends for an axial length in said passage, terminally short of said blind end.

13. A fastener according to claim 11 in which said tubular body and said washer are integral with one another.

14. A fastener according to claim 13 in which the shank of the body is tapered.

15. A fastener according to claim 6 in which a reinforcement comprising a tubular rigid body is fitted coaxially is said passage, reducing the radial width of said shank.

16. In combination:
a pair of parts made of composite material with a hole in each to be engaged by a fastener; and
a fastener according to claim 11 in which the shank of the body extends through said holes with the body head bearing against one of the parts and the body shank projecting through and beyond the other part, said puller having been turned to draw the blind end toward the head end, thereby drawing the parts together, filling the holes, and forming a bulb at the blind end.

17. A fastener according to claim 11 in which said tubular rigid body surrounds and confines part of the shank of said body.

18. A fastener according to claim 17 in which said tubular rigid body includes a head which bears against the lower face of the head of the body.

19. A fastener according to claim 11 in which said tubular rigid body fits inside said central passage in said fastener body.
